(19) United States
(12) Patent Application Publication
(10) Pub. No.: US 2015/0294391 A1
(43) Pub. Date: Oct. 15, 2015

(54) Guided Selling of Product

(71) Applicant: ExactTarget, Inc., Indianapolis, IN (US)

(72) Inventor: Richard D. Thomas, JR., Indianapolis, IN (US)

(21) Appl. No.: 14/685,078

(22) Filed: Apr. 13, 2015

Related U.S. Application Data
(60) Provisional application No. 61/978,623, filed on Apr. 11, 2014.

(51) Int. Cl. G06Q 30/06; H04L 29/06

(52) U.S. Cl. CPC G06Q 30/0631; H04L 67/42

(57) ABSTRACT

In a method for recommending a product, a first record for a characteristic of a potential user of the product can be provided. The first record can have a field for an attribute of the product with a value that can correspond to a relative degree of importance of the attribute with respect to the characteristic. A second record for a specific product can be provided. The second record can have a field for the attribute with a value that can indicate that the specific product has the attribute. A specific value for the specific product can be produced. The specific value can correspond to a relative degree of suitability of the specific product with respect to the characteristic. Information about the specific product can be transmitted to a client configured to be used by the potential user. The information can be based on the specific value.

### CROSS-REFERENCE TO RELATED APPLICATIONS

This application claims, under 35 U.S.C. §119(e), the benefit of U.S. Provisional Application No. 61/978,623, filed Apr. 11, 2014, the disclosure of which is incorporated by reference in its entirety.

### BACKGROUND

A consumer may be interested in purchasing an item of a particular type, but the variety of available items of the particular type may be overwhelming. For example, a consumer seeking to purchase a tablet computer may desire a particular operating system. After making this threshold choice, the consumer may be presented with hundreds of different options for the item with the desired operating system. Thus, the options presented to a consumer may not be meaningfully narrowed based on a single characteristic of the consumer's lifestyle or intended use of the product.

In promoting a product, producers and/or manufacturers usually emphasize technical features or other criteria to describe the product. These technical features may not be directly related to the broader question of which items are capable of addressing the consumer's needs. For example, a consumer searching for a backpack for a hiking vacation may have thousands of options from which to choose. Some backpacks may or may not have wheels, shoulder straps, a laptop compartment, waterproof material, internal pockets, outside compartments, a handle, an exterior phone pocket, etc. The size of each backpack may vary as well. Each of those backpack options may have various features that are advertised, but the advertised features may be largely unhelpful in guiding the consumer to the backpack that is appropriate for the consumer's vacation.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 provides an example overview of a method of producing a guided selling tool for a consumer.

FIG. 2 is an example overview of a platform that includes a database for storing a product set that includes attributes for one or more products.

FIG. 3A is an example of an interface that can be used to configure a guided selling tool.

FIG. 3B is an example of a guided selling tool configuration.

FIG. 3C shows an example of an interface window for the configuration of an “Activities” step.

FIG. 3D is an example of an interface window for adding an answer to the lifestyle question posed in the “Activities” step.

FIG. 4A is an example of an interface that can be used to receive answers to consumer queries.

FIG. 4B shows an example of a view of the interface that corresponds to the “Gender” step as illustrated in FIG. 3B.

FIG. 4C shows an example of a view of the interface that corresponds to the “Activities” step as illustrated in FIG. 3B.

FIG. 4D shows an example of a view of the interface that corresponds to the “Size” step as illustrated in FIG. 3B.

FIG. 4E shows an example of a view of the interface that corresponds to the “Needs” step as illustrated in FIG. 3B.

FIG. 4F shows an example of a view of the interface that corresponds to the “Results” step as illustrated in FIG. 3B.

FIG. 5 is a flow diagram illustrating an example of a method for recommending a product or a service.

FIG. 6 illustrates examples of sets of records for sets of characteristics of a potential user of a product or a service.

FIG. 7 illustrates examples of sets of records for sets of specific products or sets of specific service providers.

FIG. 8 is a flow diagram illustrating an example of another method for recommending a product or a service.

FIG. 9 is a flow diagram illustrating an example of a method for receiving the subset of the set of characteristics as illustrated in FIG. 8.

FIG. 10 is a block diagram of an example of a system for recommending a product or a service.

FIG. 11 is a block diagram of an example of a computer.

FIG. 12 shows an example of a network arrangement.

### DETAILED DESCRIPTION

Existing systems may permit a user to filter products based on attributes of the products, such as, for example, a monitor size range, a color, and/or dimensions. While such a method may be effective when a relatively few number of products are returned as results of a search, the method may overwhelm the consumer when hundreds or thousands of products match the consumer's specified criteria. Further, many products may differentiate themselves based on technical specifications and/or features that may not be directly related to the consumer's needs.

Generally, consumers have an intended use for a particular product. When a consumer enters a retail store, the consumer has the option of speaking with a sales representative who can guide the consumer to appropriate items given the consumer's expressed needs. Implementations disclosed herein may assist those consumers who elect to research and purchase products over the Internet by posing lifestyle-based questions to the consumer. Based on the responses to the lifestyle questions, the system can match a consumer to one or more products contained in a database. Thus, rather than have a consumer filter products based on a list of technical specifications, the consumer can narrow product choices based on an intended use. The disclosed implementations can more closely approximate an in-store experience in which the consumer can speak to a salesperson to determine products that would accommodate the consumer's lifestyle, preferences, and/or intended use.

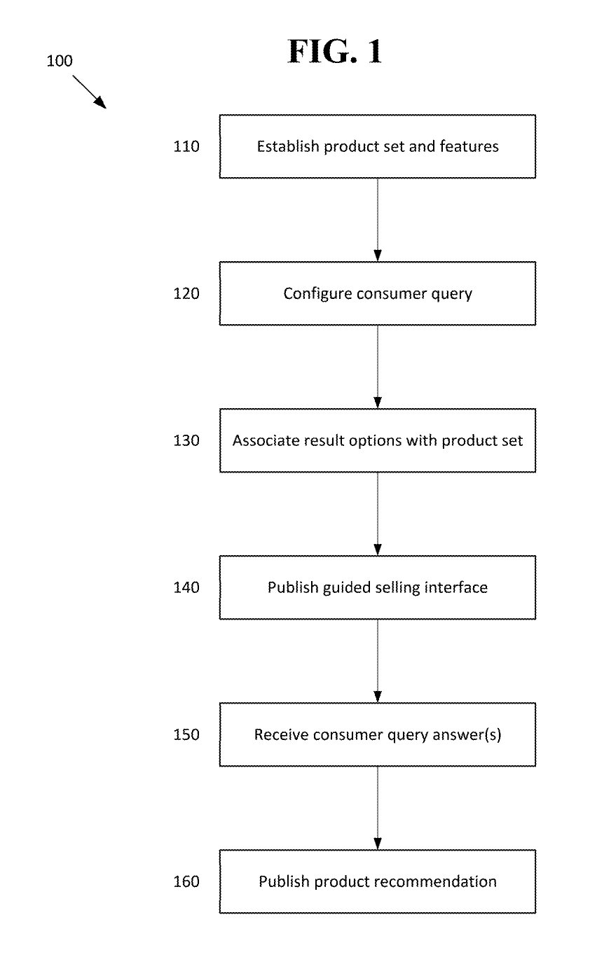

FIG. 1 provides an example overview of a method 100 of producing a guided selling tool for a consumer that, in response to received query answers, can publish a product recommendation according to an implementation disclosed herein. The method 100 may begin at an operation 110 by establishing a product set and/or features. A product set or feature may refer to an attribute of a particular consumer good. For example, an attribute for a television set may be a screen size, a resolution, a technology (e.g., LED, DLP, plasma, LCD, etc.). As another example, a backpack may have defined attributes that include the volume, a number of pockets, a type of carry mechanism (e.g., straps, a shoulder strap), a weight, and a material composition (e.g., the type of textile that it is made from). As another example, a tablet computer may have attributes that describe the screen size, a number of cameras, a screen resolution, a RAM amount, a processor speed, a storage size, and a battery size. The product set can be uploaded or entered into a database using techniques known to a person having ordinary skill in the art.

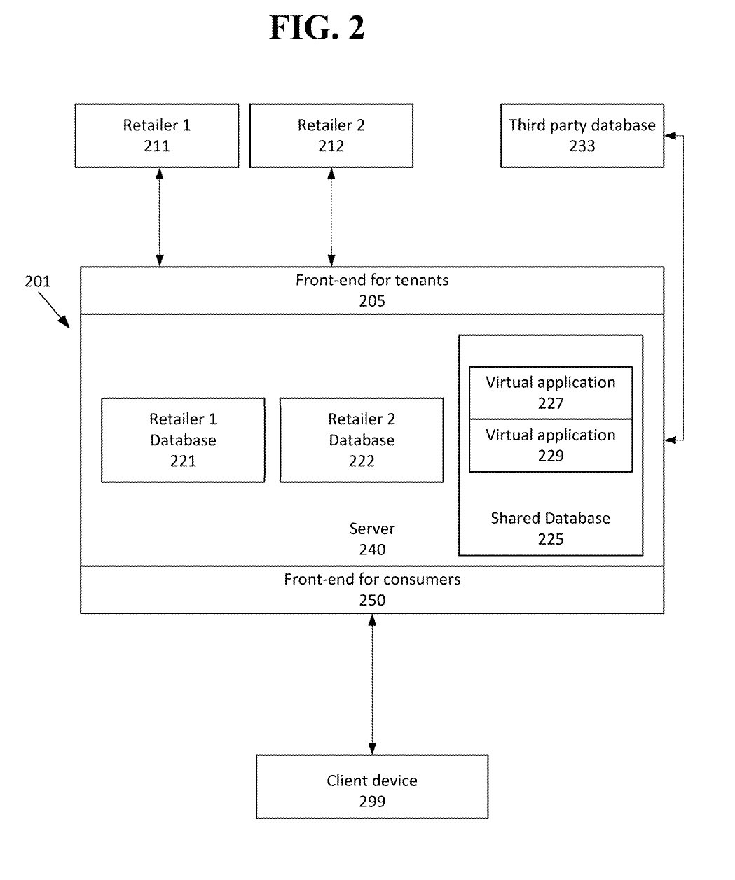

FIG. 2 is an example overview of a platform 201 that includes a database for storing a product set that includes attributes for one or more products as disclosed herein. In an implementation, the platform 201 may be included in an enterprise information system. One or more retailers 211, 212 may simultaneously use the platform 201 shown in FIG. 2. A retailer 211, 212 may use the platform 201 to provide a backbone for a web-based store front-end 250 that can be viewed on a client device 299 used by a user. The data of a retailer may be separate from the data of another retailer, such as in a multi-tenant system. For example, information related to web-based transactions for the first retailer 211 may be stored in a database 221 and may be distinct from information related to web-based transactions for the second retailer 212, which may be stored in a database 222, even though both electronic storefronts 250 for the retailers 211, 212 may be provided by the platform 201. Thus, each retailer 211, 212 may be considered a tenant in a multi-tenant system.

The platform 201 may include a server 240 that can generate and/or provide one or more virtual applications 227, 229 based on data stored in a common database 225 shared between the tenants (e.g., the retailers 211, 212). A virtual application 227, 229 may provide access to data in the database 225 for one or more tenants using the system. For example, a virtual application 227 may be provided for a tenant that provides for data entry/submission of information related to a product into the database 225. For example, another virtual application 229 may be provided that allows a tenant to configure a consumer query as shown in FIG. 1 at 120. Access to a particular virtual application 227, 229 may be controlled by the platform 201 and based on a subscription of the retailer 211, 212. For example, the first retailer 211 may have an all-inclusive subscription that grants access to both of the virtual applications 227, 229 shown in FIG. 2 while the second retailer's 212 subscription may only grant access to the first virtual application 227. The retailers 211, 212, or tenants of the system, may access the platform 201 using an interface 205 that differs from the interface 250 presented to consumers. The tenant interface 205 may have a distinct URL that is not associated with the retailer's web site 250 URL. For example, the first retailer 211 may operate a storefront 250 via the platform 201 for company ABC. The URL for ABC, which may be publicly accessible to consumers, may be www.ABC.com. In contrast, the URL for the front-end 205 for tenants may be www.platform.com/ABC and may further be protected by techniques, such as, for example, a username and password.

A tenant may refer to a group of customers that shares access to common data within a database. A tenant may represent customers, customer departments, business or legal organizations, and/or any other entities that maintain data for particular sets of users. For example, a tenant may request social media posts, metadata, and/or analytics provider data. Although multiple tenants may share access to a common server 240 and database 225, the particular data and services provided from the system to each tenant can be securely isolated from those provided to other tenants. The multi-tenant architecture therefore may allow different sets of tenants to share functionality without necessarily sharing each other's data. Similarly, the appearance of a tenant's interface with the system may be unique and/or configurable. Similarly, the presentation and/or organization of the data stored in a tenant's database 221, 222 may be specific to that tenant.

With reference to FIGS. 1 and 2, at the operation 110, the product attributes may be established based on retailer-entered data. In some configurations, a third party database 233 may be connected to the platform 201 to provide product attributes. For example, a retailer may maintain a database that includes, for each product, an identifier that corresponds to a product name, model, make, product number, etc. A retailer 211, 212 may update the database to include a new product and the corresponding identifier information via the frontend for tenants 205. The platform 201 may query the third party database 233 to ascertain product information. For example, a well-known tablet computer manufacturer, PHABTAB, may operate a publicly accessible website that contains product information for a particular model tablet computer. A retailer may enter PHABTAB tablet computer model number ABBA into the interface 205 of the platform 201. The platform may query the third party database 233, belonging to PHABTAB's website, for information about the ABBA tablet computer. The third party database 233 may return product information that the third party database 233 has available. In some instances, PHABTAB's website may not return information to the platform 201. Rather, the platform 201 may obtain information from the manufacturer's website by extracting data based on a key word search. For example, the platform 201 may query PHABTAB's website for ABBA. On the page that is returned, the platform 201 may search for “specifications” or other key words that might indicate attributes of ABBA. On a specifications page, the platform 201 may extract data associated, for example, with screen size, RAM, or memory based on a key word search therefor. For example, it may determine that “2 GB” is related to the word “RAM” and use 2 GB as the amount of RAM in ABBA. For example, some manufacturers may use the platform 201 to store product attributes in a database that is a part of the platform 201. That database may be queried by the platform 201 to obtain attributes for products sole at a particular retailer's store. Thus, in some configurations, at the operation 110, the platform 201 may auto-populate attribute data for the retailer or otherwise establish a product set and/or features.

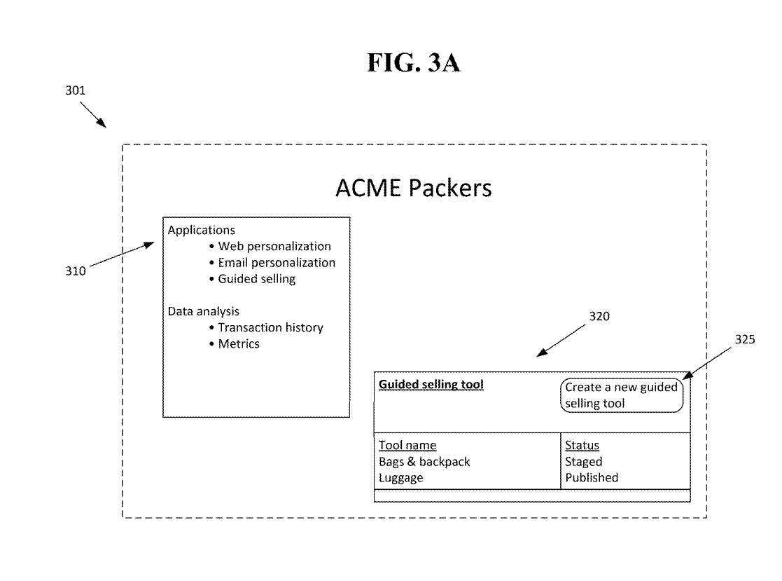

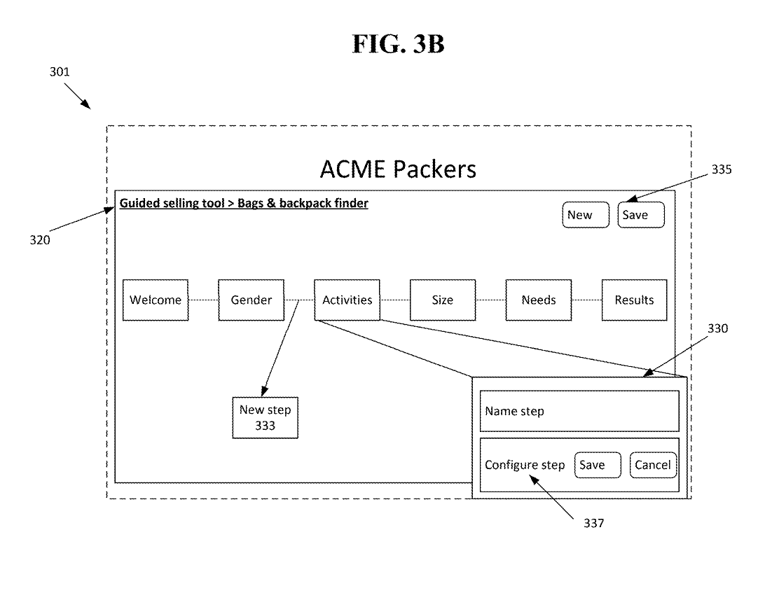

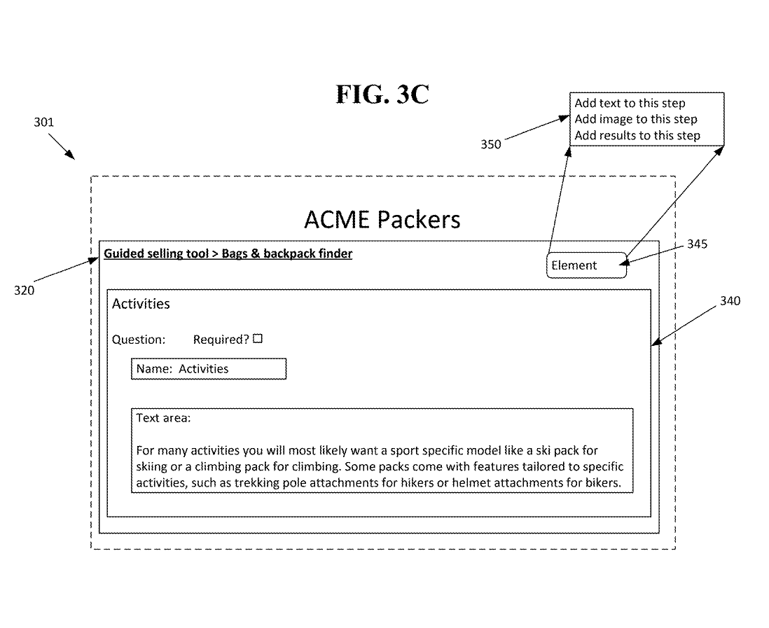

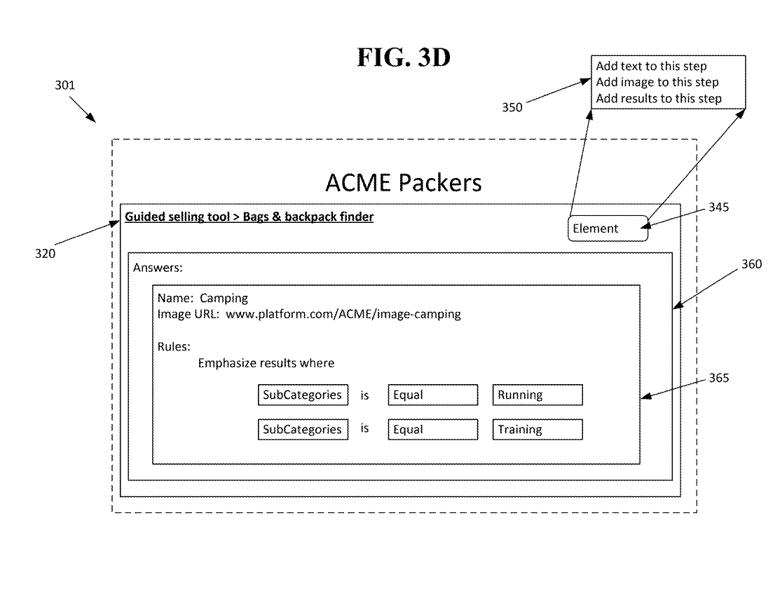

At an operation 120, a retailer may use the platform 201 to configure one or more guided consumer queries. A question may be directed toward determining a consumer's intended use and/or filtering a large pool of products that meet the consumer's needs. FIG. 3A is an example of an interface 301 that can be used to configure a guided selling tool. For example, the interface 301 may be presented, via the platform 201 (see FIG. 2), to a retailer. The interface 301 may be customized for the particular retailer, which, in the example shown in FIG. 3A, is ACME Packers. The interface 301 may show a sub-area 310 in which various applications and/or data analysis tools may be presented. For example, if the retailer selects the “Guided selling” application, then another window may appear in the interface 310 corresponding to the Guided selling tool 320. In this window, the retailer can see currently set-up guided selling tools. FIG. 3A shows, for example, currently set-up guided selling tools for “Bags & backpack” and “Luggage.” The status of each established tool is also shown. For example, the status of “Bags & backpack” is shown as “staged” while the status of “Luggage” is shown as “published.” “Staged” may refer to a tool that has been previously saved, but is not currently deployed to the consumer facing interface 250 (see FIG. 2) for the retailer. “Published” may refer to a tool that is currently deployed on the consumer-accessible site 250. For example, a user may select an interface element to create a new guided selling tool 325 or to select one of the existing tools in the event that the user would like to edit one of the existing tools.

FIG. 3B is an example of a guided selling tool configuration as disclosed herein. For example, FIG. 3B shows a guided selling tool for the Bags & backpacks finder. For example, a window may appear that provides an overview of the current guided selling tool for the selected tool 320. Interface elements 335 may allow a user to generate a new step and/or save the current configuration. As an example, a user can select one of the connectors linking two steps to create a new step as shown at element 333. Similarly, selecting one of the existing steps, such as “Activities,” may cause a configuration window 330 to appear. The configuration window 330 may provide an interface for a user to name the step and/or to configure the step. For example, a guided selling tool can have steps, texts, videos, and images. Images may be any image assets used be any application that uses the guided selling application program interface to provide a tool-based consumer experience. A retailer may create two guided selling tools for a single website, such as, for example, a backpack finder and a tent finder. The retailer may wish to use one background image for one finder and a different background image for another finder. The retailer may configure each finder to have a particular background image. Steps may refer to any logical representation of steps in a guided selling experience. For example, a retailer may configure a welcome step, two question steps, and a results step. A step may have an image, a text, a question, and/or results. The image may be any image asset for the specific step, such as, for example, an icon to be displayed on the specific step. A text may be any key or value text entry, such as, for example, a name of the step. A result may refer to a step that provides a recommendation for products that match or resemble the answers provided by a consumer to the lifestyle questions.

Selecting “configure step” 337 may cause a new window to be displayed by the platform 201 (see FIG. 2). FIG. 3C shows an example of an interface window 340 for the configuration of an “Activities” step as disclosed herein. For example, the interface window 340 may include a reference to the name of the step to which the information pertains (“Activities” in this case). The interface window 340 may display a selectable box or other method of indicating whether the question is required in the sequence of steps of the guided selling tool. A retailer may enter, in a text area of the interface window 340, text that poses a question, describes a product area, and/or provides some guidance to the consumer for this step. In this example, the text provides some guidance regarding the type of backpack. A selectable element 345 is shown that may display, for example, another interface element 350 through which a retailer may add text to the step, add one or more images to the step, and/or add a result of the step. For example, a retailer may select “add image” and may upload, to the platform 201 (see FIG. 2), an image to be displayed for this step. The interface window may provide an area in which a retailer may enter or add one or more image URLs. The interface window 340 may show, to a consumer, a representation of how the web page will appear to the consumer. The retailer may position the one or more images (including video) and text. Editing functions may be provided when viewing the representation of the web page, such as, for example, an ability to add, delete, and/or edit images and/or text as well as import graphics or other pictures.

A query step may ask a user to answer one or more questions, the answers for which may be associated with attributes of products stored in the database of the platform 201 (see FIG. 2). The questions may include a range-based question (e.g., the capacity of a backpack in a range from small to high, megapixel range of a camera from small to high, etc.), single-select questions (e.g., questions calling for a radio-button response), multi-answer questions, and/or free-form questions.

A component of the query step (e.g., “Activities”) may be a variable that can be defined by a style sheet, web services layer, and/or other presentation medium for the guided selling tool. For example, a retailer offering shoes for sale may generate a guided selling tool related to different classes of heels. In this example, the retailer may include a variable for a placeholder image that instructs a web service layer, during presentation, to provide an appropriate image for the consumer based on the consumer's referring URL, HTTP header information, attributes about the consumer, and/or other information. For example, a logo from referring domain may be utilized as a placeholder image.

At an operation 130 (see FIG. 1), one or more result options may be associated with a product set. FIG. 3D is an example of an interface window 360 for adding an answer to the lifestyle question posed in the “Activities” step. The interface window 360 shows potential “answers” to the “activities” question. An answer may be shown in a sub-window 365. In the example shown in FIG. 3D, one answer to the type of activity a consumer may engage in is “camping.” For example, the sub-window 365 may show an image URL that corresponds to the image that will be displayed with this particular answer. For example, the sub-window 365 may display a rule applicable to this particular answer. As an example, rules for “camping” show that the subcategories “running” or “training” are to be “emphasized.” “Emphasis” may be placed, for example, by an exact match to any product in the database that has indicated that at least one of running or training is an appropriate use for the backpack. Other backpacks may have related descriptions of appropriate use, such as, for example, “hiking,” that, in some configurations, may not be returned as a result to the consumer. The results of the query may be stratified, according to the consumer's specified answers to each of the questions posed by the retailer, in order of those products that best match the consumer's answers. For example, if a consumer has specified camping as an activity, then the results may be presented according to those that match camping followed by those that match a related activity such as hiking Other rules may be specified to exclude or include one or more subcategories of products from the presented results. For example, if a consumer provides an answer that camping is the activity, then the rules may exclude those backpacks related to bicycling from the presented results. The rules may specify attributes of the products provided to the database of the platform 201 (see FIG. 2) to ascertain whether to include a product as a result and/or to rank the product within the results provided to the consumer. In some configurations, a step may be directed toward answers that may filter products in the product set based on features. The relationship may be stored in a database using techniques known to a person of ordinary skill in the art. Thus, a retailer may configure a step to match attributes of products and narrow the products presented to the consumer.

At an operation 140 (see FIG. 1), the retailer may publish the guided selling tool that has been created, thereby making the selling tool available to consumers.

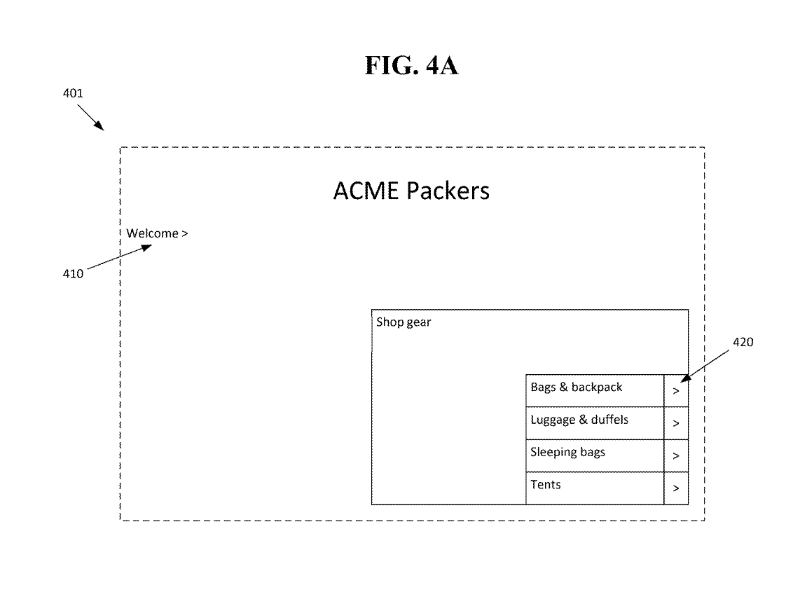

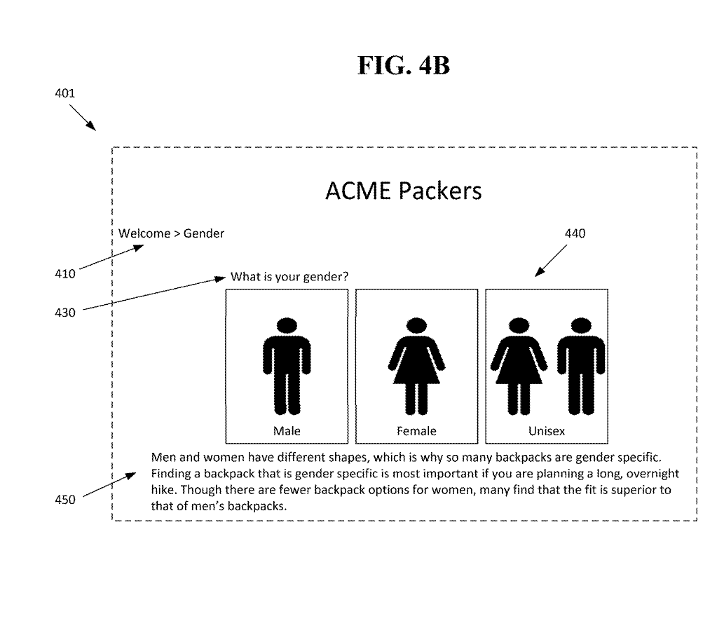

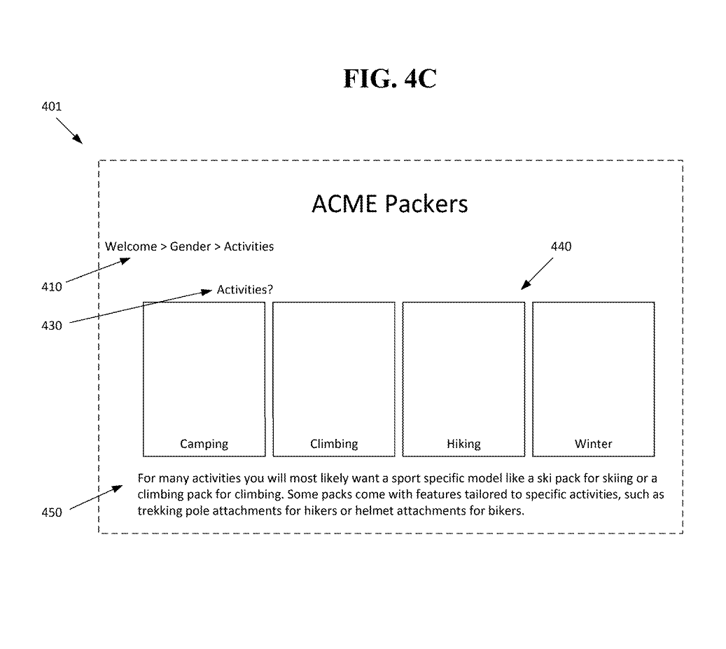

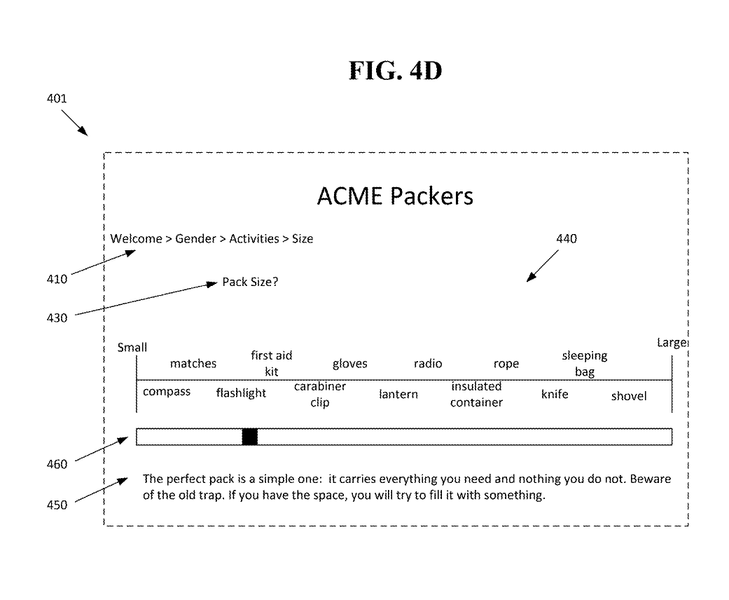

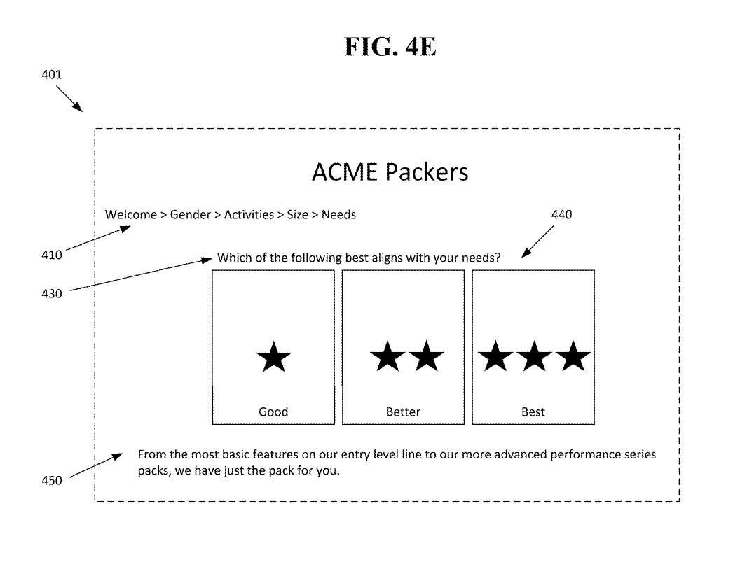

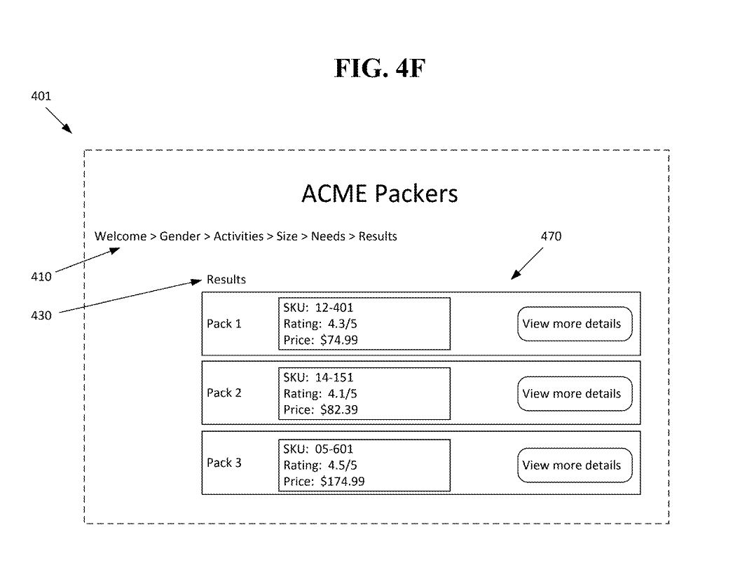

At an operation 150 (see FIG. 1), answers to one or more guided consumer queries may be received at the platform 201 (see FIG. 2). FIG. 4A is an example of an interface 401 that can be used to receive answers to consumer queries. For example, the interface 401 may be presented, via the platform 201, to a consumer. The interface 401 may be customized for the particular retailer, which, in the example shown in FIG. 4A, is ACME Packers. The interface 401 may include be arranged in steps, which may be presented as a sequence of screens. The example shown in FIG. 4A may correspond to a “Welcome” step as illustrated in FIG. 3B. Accordingly, the interface 401 may show a step title 410 to indicate which step in the interface 401 is currently presented to the consumer. The interface 401 may also show a window that presents guided selling tools available to the consumer. In the example shown in FIG. 4A, guided selling tools are available for “Bags & backpack,” “Luggage & duffels,” “Sleeping bags,” and “Tents.” Each of the guided selling tools has a corresponding graphical control element 420 to allow the consumer to select that particular guided selling tool. Optionally, the graphical control element 420 can include an image of the product that corresponds to the particular guided selling tool.

FIG. 4B shows an example of a view of the interface 401 that corresponds to the “Gender” step as illustrated in FIG. 3B. Accordingly, the step title 410 shown in FIG. 4B may indicate to the consumer that the “Gender” step of the interface 401 is currently presented to the consumer. The “Gender” step of the interface 401 may include a first text area 430 that states the query, representations of answers to the query 440, and a second text area 450, corresponding to the “text area” illustrated in FIG. 3C, that describes a product area and/or provides some guidance to the consumer in selecting her answer to the query. Optionally, the representations of answers to the query 440 can include graphical control elements to allow the consumer to respond to the query. Optionally, a graphical control element can include an image that corresponds to an answer to the query.

FIG. 4C shows an example of a view of the interface 401 that corresponds to the “Activities” step as illustrated in FIG. 3B. Accordingly, the step title 410 shown in FIG. 4C may indicate to the consumer that the “Activities” step of the interface 401 is currently presented to the consumer. The “Activities” step of the interface 401 may include the first text area 430 that states the query, the representations of answers to the query 440, and the second text area 450, corresponding to the “text area” illustrated in FIG. 3C, that describes a product area and/or provides some guidance to the consumer in selecting her answer to the query. Optionally, the representations of answers to the query 440 can include graphical control elements to allow the consumer to respond to the query. Optionally, a graphical control element can include an image that corresponds to an answer to the query. In the example shown in FIG. 4C, four different answers, “Camping,” “Climbing,” “Hiking, and “Winter” are presented to the consumer regarding the activities for which she anticipates using the backpack. The second text area 450 includes information that explains to the consumer the significance of the different answers with respect to the ultimate product recommendation.

FIG. 4D shows an example of a view of the interface 401 that corresponds to the “Size” step as illustrated in FIG. 3B. Accordingly, the step title 410 shown in FIG. 4D may indicate to the consumer that the “Size” step of the interface 401 is currently presented to the consumer. The “Size” step of the interface 401 may include the first text area 430 that states the query, the representations of answers to the query 440, and the second text area 450, corresponding to the “text area” illustrated in FIG. 3C, that describes a product area and/or provides some guidance to the consumer in selecting her answer to the query. The “Size” step of the interface 401 may include a graphical control element 460 to allow the consumer to respond to the query. In the example shown in FIG. 4D, the graphical control element 460 may be an analog scale that the consumer can adjust, using the representations of answers to the query 440 and the information in the second text area 450 as guides, to select a size of the backpack that meets her needs. For example, as shown in the representations of answers to the query 440 in FIG. 4D, the size of the backpack may be a function of what it needs to carry, which may range from small items (e.g., compass, matches, flashlight, etc.) to progressively larger items (e.g., sleeping bag, shovel, etc.). Against this backdrop of information, the consumer can use the analog scale of the graphical control element 460 to estimate a size of the backpack that she will need.

FIG. 4E shows an example of a view of the interface 401 that corresponds to the “Needs” step as illustrated in FIG. 3B. Accordingly, the step title 410 shown in FIG. 4E may indicate to the consumer that the “Needs” step of the interface 401 is currently presented to the consumer. The “Needs” step of the interface 401 may include the first text area 430 that states the query, the representations of answers to the query 440, and the second text area 450, corresponding to the “text area” illustrated in FIG. 3C, that describes a product area and/or provides some guidance to the consumer in selecting her answer to the query. Optionally, the representations of answers to the query 440 can include graphical control elements to allow the consumer to respond to the query. Optionally, a graphical control element can include an image that corresponds to an answer to the query. In the example shown in FIG. 4E, the “Needs” step may allow the consumer to grade the relevancy of the previous steps with respect to the factors that she values in selecting the product. For example, if the information provided in the previous steps is somewhat relevant to the factors she values in selecting a backpack, she may answer “Good,” if they are more than somewhat relevant, she may answer “Better,” and if they are very relevant, she may answer “Best.”

At an operation 160 (see FIG. 1), the interface 401 may publish a product recommendation. FIG. 4F shows an example of a view of the interface 401 that corresponds to the “Results” step as illustrated in FIG. 3B. Accordingly, the step title 410 shown in FIG. 4F may indicate to the consumer that the “Results” step of the interface 401 is currently presented to the consumer. The “Results” step of the interface 401 may include the first text area 430, which states that the results are being presented, and a window 470 in which a presentation of the results is displayed. In the example shown in FIG. 4F, more than one result is displayed. In the example shown in FIG. 4F, basic information for each result (e.g., the SKU number, a consumer rating number, and a price) is displayed. In the example shown in FIG. 4F, the presentation for each result includes a graphical control element that may be used to obtain more details about the corresponding result. Optionally, a presentation of a result can include an image of the recommended product.

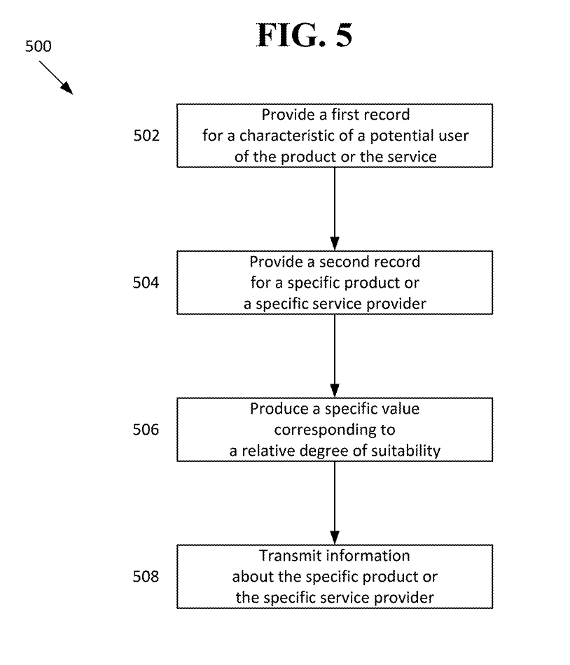

FIG. 5 is a flow diagram illustrating an example of a method 500 for recommending a product or a service. In the method 500, at an operation 502, a first record can be provided from a memory. The first record can be for a characteristic of a potential user of the product or the service. The first record can have a field for an attribute of the product or the service. A value of the field of the first record can correspond to a relative degree of importance of the attribute with respect to the characteristic.

In an implementation, the value of the field of the first record can be produced as a result of research about consumer preferences about the attribute with respect to the characteristic. In an implementation, an update to the value of the field of the first record can be received in the memory on a routine basis. In an implementation, the update can be received in response to a query for the update.

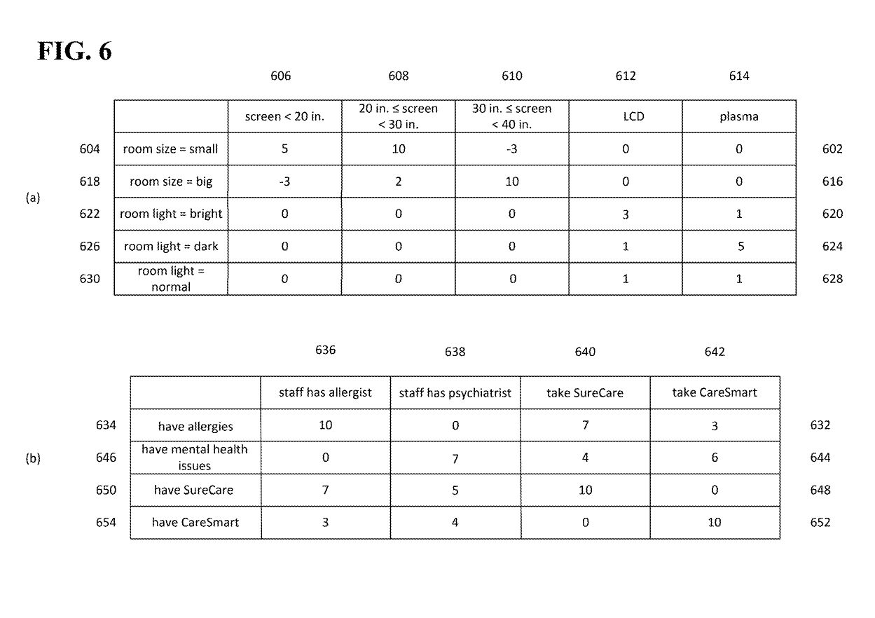

FIG. 6 illustrates examples of sets of records for sets of characteristics of a potential user of a product or a service. A view (a) of FIG. 6 illustrates an example of a first record 602 in an example case in which the product is a television set. The first record 602 can be for the characteristic that the potential user intends to view the television set in a small room 604. The first record 602 can have a field for an attribute that the television set has a screen smaller than 20 inches 606. A value of the field 606 of the first record 602 (i.e., 5) can correspond to the relative degree of importance of the attribute (i.e., having a screen smaller than 20 inches) with respect to the characteristic 604 (i.e., intending to view the television set in a small room). The range of values can be arbitrary. In the set of records illustrated in the view (a) of FIG. 6, the range of values can be, for example, inclusively from −10 to 10. A negative value can be used to indicate that a specific attribute is specifically not important with respect to a specific characteristic.

In an implementation, the first record 602 can have a plurality of fields for a plurality of attributes. For example, in addition to the first field for the first attribute that the television set has a screen smaller than 20 inches 606, the first record 602 can have a second field for a second attribute that the television set has a screen greater than or equal to 20 inches but less than 30 inches 608, a third field for a third attribute that the television set has a screen greater than or equal to 30 inches but less than 40 inches 610, a fourth field for a fourth attribute that the television set has a liquid-crystal display (LCD) screen technology 612, and a fifth field for a fifth attribute that the television set has a plasma display panel (plasma) screen technology 614. The number of fields (for the number of attributes) can be any number and is not limited to five.

In an implementation, there can be a set of first records. For example, in addition to the first record 602 for the characteristic that the potential user intends to view the television set in a small room 604, there can be a first record 616 for the characteristic that the potential user intends to view the television set in a big room 618, a first record 620 for the characteristic that the potential user intends to view the television set in a brightly lit room 622, a first record 624 for the characteristic that the potential user intends to view the television set in a darkly lit room 626, and a first record 628 for the characteristic that the potential user intends to view the television set in a normally lit room 630. The number of first records (for the number of characteristics) can be any number and is not limited to five. Moreover, the number of fields (for the number of attributes) does not need to be equal to the number of first records (for the number of characteristics).

For each field of each first record, a value of the field for the first record can correspond to the relative degree of importance of the corresponding attribute with respect to the corresponding characteristic.

A view (b) of FIG. 6 illustrates an example of a first record 632 in an example case in which the service is a medical practice. The first record 632 can be for the characteristic that the potential user has allergies 634. The first record 632 can have a field for an attribute that the medical practice has an allergist on staff 636. A value of the field 636 of the first record 632 (i.e., 10) can correspond to the relative degree of importance of the attribute (i.e., having an allergist on staff) with respect to the characteristic 634 (i.e., having allergies).

In an implementation, the first record 632 can have a plurality of fields for a plurality of attributes. For example, in addition to the first field for the first attribute that the medical practice has an allergist on staff 636, the first record 632 can have a second field for a second attribute that the medical practice has a psychiatrist on staff 638, a third field for a third attribute that the medical practice is in the SureCare health insurance network 640, and a fourth field for a fourth attribute that the medical practice is in the CareSmart health insurance network 642. The number of fields (for the number of attributes) can be any number and is not limited to four.

In an implementation, there can be a set of first records. For example, in addition to the first record 632 for the characteristic that the potential user has allergies 634, there can be a first record 644 for the characteristic that the potential user has mental health issues 646, a first record 648 for the characteristic that the potential user has health insurance through SureCare 650, and a first record 652 for the characteristic that the potential user has health insurance through CareSmart 654. The number of first records (for the number of characteristics) can be any number and is not limited to four. Moreover, the number of fields (for the number of attributes) does not need to be equal to the number of first records (for the number of characteristics).

For each field of each first record, a value of the field for the first record can correspond to the relative degree of importance of the corresponding attribute with respect to the corresponding characteristic.

Returning to FIG. 5, at an operation 504, a second record can be provided from the memory. The second record can be for a specific product or a specific service provider. The second record can have a field for the attribute. A value of the field of the second record can indicate that the specific product or the specific service provider has the attribute.

In an implementation, the value of the field of the second record can be provided from a producer or a seller of the specific product, from the specific service provider, from a third party, or from any combination of the foregoing. In an implementation, the value of the field of the second record can be received in the memory on a routine basis. In an implementation, the value of the field of the second record can be received in the memory in response to a query for the value. In an implementation, the value of the field of the second record can be copied from information made available to the public by the producer or the seller of the specific product, by the specific service provider, by a third party, or by any combination of the foregoing.

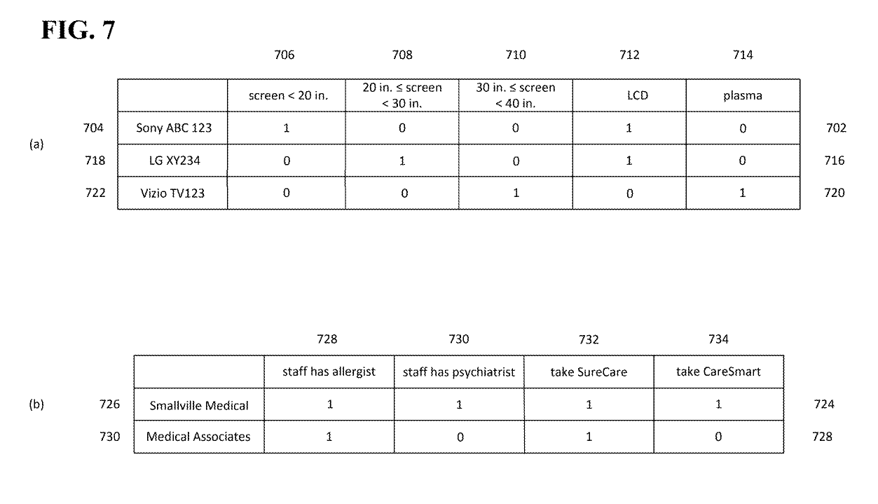

FIG. 7 illustrates examples of sets of records for sets of specific products or sets of specific service providers. A view (a) of FIG. 7 illustrates an example of a second record 702 in the example case in which the product is a television set. The second record 702 can be for the specific product of the Sony ABC 123 television set 704. The second record 702 can have a field for the attribute that the television set has a screen smaller than 20 inches 706. A value of the field 706 of the second record 702 (i.e., 1) can indicate that the specific product (i.e., the Sony ABC 123 television set 704) has the attribute (i.e., having a screen smaller than 20 inches). The values can be either 1 or 0. For example, a value of 1 can indicate that the specific product has the attribute, while a value of 0 can indicate that the specific product does not have the attribute.

In an implementation, the second record 702 can have a plurality of fields for a plurality of attributes. For example, in addition to the first field for the first attribute that the television set has a screen smaller than 20 inches 706, the second record 702 can have a second field for the second attribute that the television set has a screen greater than or equal to 20 inches but less than 30 inches 708, a third field for the third attribute that the television set has a screen greater than or equal to 30 inches but less than 40 inches 710, a fourth field for the fourth attribute that the television set has a liquid-crystal display (LCD) screen technology 712, and a fifth field for the fifth attribute that the television set has a plasma display panel (plasma) screen technology 714. The number of fields (for the number of attributes) can be any number and is not limited to five.

In an implementation, there can be a set of second records. For example, in addition to the second record 702 for the specific product of the Sony ABC 123 television set 704, there can be a second record 716 for the specific product of the LG XY234 television set 718 and a second record 720 for the specific product of the Vizio TV123 television set 722. The number of second records (for the number of specific products) can be any number and is not limited to three.

For each field of each second record, a value of the field of the second record can indicate that the corresponding specific product has the corresponding attribute.

A view (b) of FIG. 7 illustrates an example of a second record 724 in the example case in which the service is a medical practice. The second record 724 can be for the specific service provider Smallville Medical 726. The second record 724 can have a field for the attribute that the medical practice has an allergist on staff 728. A value of the field 728 of the second record 724 (i.e., 1) can indicate that the specific service provider (i.e., Smallville Medical) has the attribute (i.e., having an allergist on staff).

In an implementation, the second record 724 can have a plurality of fields for the plurality of attributes. For example, in addition to the first field for the first attribute that the medical practice has an allergist on staff 728, the second record 724 can have a second field for the second attribute that the medical practice has a psychiatrist on staff 730, a third field for a third attribute that the medical practice is in the SureCare health insurance network 732, and a fourth field for a fourth attribute that the medical practice is in the CareSmart health insurance network 734. The number of fields (for the number of attributes) can be any number and is not limited to four.

In an implementation, there can be a set of second records. For example, in addition to the second record 724 for the specific service provider Smallville Medical 726, there can be a second record 728 for the specific service provider Medical Associates 730. The number of second records (for the number of specific service providers) can be any number and is not limited to two.

For each field of each second record, a value of the field of the second record can indicate that the corresponding specific service provider has the corresponding attribute.

Returning to FIG. 5, at an operation 506, a specific value can be produced at a processor. The specific value can correspond to a relative degree of suitability of the specific product or the specific service provider with respect to the characteristic.

By way of example, and not by way of limitation, the specific value can be equal to a product of the value of the field of the first record multiplied by the value of the corresponding field of the second record. For example, in the example case in which the product is a television set, as illustrated in the views (a) of FIGS. 6 and 7, the specific value for the specific product of the Sony ABC 123 television set 704 with respect to the characteristic that the potential user intends to view the television set in a small room 604 can be equal to the product of the value of the field for the attribute that the television set has a screen smaller than 20 inches 606 of the first record 602 (i.e., 5) multiplied by the value of the field for the attribute 706 of the second record 704 (i.e., 1), which is 5. For example, in the example case in which the service is a medical practice, as illustrated in the views (b) of FIGS. 6 and 7, the specific value for the specific service provider Smallville Medical 726 with respect to the characteristic that the potential user has allergies 634 can be equal to the product of the value of the field for the attribute that the medical practice has an allergist on staff 636 of the first record 632 (i.e., 10) multiplied by the value of the field for the attribute 728 of the second record 724 (i.e., 1), which is 10.

In an implementation in which each of the first record and the second record has a plurality of fields for the plurality of attributes, the specific value can be equal to a sum of products. Each product of the products can be the value of the field of the first record multiplied by the value of the corresponding field of the second record. For example, in the example case in which the product is a television set, as illustrated in the views (a) of FIGS. 6 and 7, the specific value for the specific product of the Sony ABC 123 television set 704 with respect to the characteristic that the potential user intends to view the television set in a small room 604 can be equal to the sum of the products (5×1)+(10×0)+(−3×0)+(0×1)+(0×0), which is 5. For example, in the example case in which the service is a medical practice, as illustrated in the views (b) of FIGS. 6 and 7, the specific value for the specific service provider Smallville Medical 726 with respect to the characteristic that the potential user has allergies 634 can be equal to the sum of the products (10×1)+(0×1)+(7×1)+(3×1), which is 20.

In an implementation in which there is a set of first records for a set of characteristics, the specific value can correspond to the relative degree of suitability of the specific product or the specific service provider with respect to the set of characteristics. In an implementation, the specific value can be equal to a sum of all sums of products. Each sum of the sums of products can correspond to a first record in the set of first records. For example, in the example case in which the product is a television set, as illustrated in the views (a) of FIGS. 6 and 7, the specific value for the specific product of the Sony ABC 123 television set 704 with respect to the characteristic that the potential user intends to view the television set in a small room 604, the characteristic that the potential user intends to view the television set in a big room 618, the characteristic that the potential user intends to view the television set in a brightly lit room 622, the characteristic that the potential user intends to view the television set in a darkly lit room 626, and the characteristic that the potential user intends to view the television set in a normally lit room 630 can be equal to the sum of all the sums of the products [(5×1)+(10×0)+(−3×0)+(0×1)+(0×0)]+[(−3×1)+(2×0)+(10×0)+(0×1)+(0×0)]+[(0×1)+(0×0)+(0×0)+(3×1)+(1×0)]+[(0×1)+(0×0)+(0×0)+(1×1)+(5×0)]+[(0×1)+(0×0)+(0×0)+(1×1)+(1×0)], which is 7. Such a specific value can correspond the overall relative degree of suitability of the Sony ABC 123 television set 704. For example, in the example case in which the service is a medical practice, as illustrated in the views (b) of FIGS. 6 and 7, the specific value for the specific service provider Smallville Medical 726 with respect to the characteristic that the potential user has allergies 634, the characteristic that the potential user has mental health issues 646, the characteristic that the potential user has health insurance through SureCare 650, and the characteristic that the potential user has health insurance through CareSmart 654 can be equal to the sum of all the sums of the products [(10×1)+(0×1)+(7×1)+(3×1)]+[(0×1)+(7×1)+(4×1)+(6×1)]+[(7×1)+(5×1)+(10×1)+(0×1)]+[(3×1)+(4×1)+(0×1)+(10×1)], which is 76. Such a specific value can correspond the overall relative degree of suitability of Smallville Medical 726.

Returning to FIG. 5, at an operation 508, information about the specific product or the specific service provider can be transmitted to a client configured to be used by the potential user. The information can be based on the specific value. In an implementation, the information can be transmitted in response to the specific value being greater than a threshold. For example, a graphical representation of the information can be produced, configured to be presented via a graphical user interface, in the manner illustrated in FIG. 4F.

In an implementation in which there is a set of second records for a set of specific products or specific service providers, the specific value can include a set of specific values. The set of specific values can correspond to the set of specific products or specific service providers. The information can include a set of information. The set of information can correspond to the set of specific products or specific service providers. The information in the set of information can be configured to be presented in an order. The order can be according the specific values of the set of specific values. For example, in the example case in which the product is a television set, as illustrated in the views (a) of FIGS. 6 and 7, the set of specific values can include the specific value for the specific product of the Sony ABC 123 television set 704, the specific value for the specific product of the LG XY234 television set 718, and the specific value for the specific product of the Vizio TV123 722. For example, in the example case in which the service is a medical practice, as illustrated in the views (b) of FIGS. 6 and 7, the specific value for the specific service provider Smallville Medical 726 and the specific value for the specific service provider Medical Associates 730.

In an implementation, the memory, the processor, or both can be included in a server. The server can be configured to interact with the client via a network.

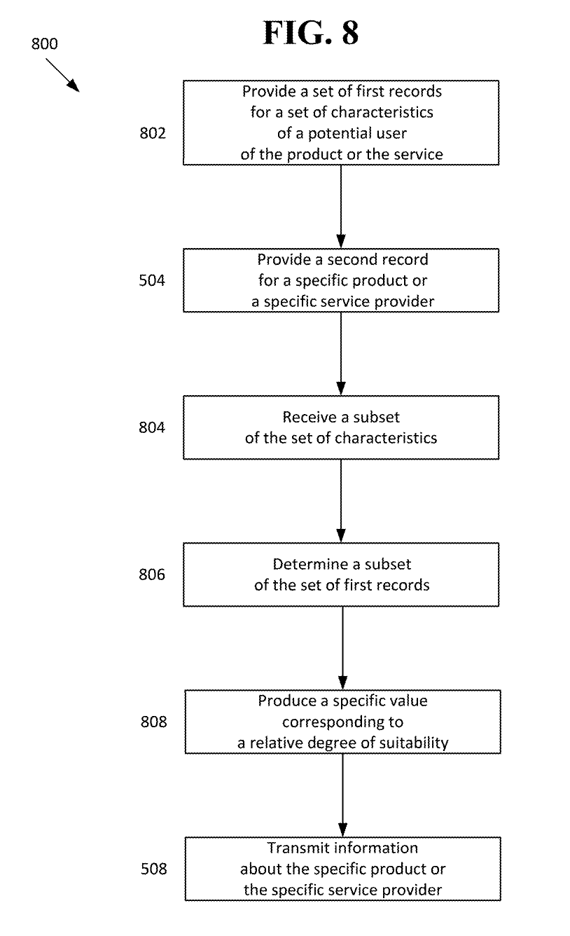

FIG. 8 is a flow diagram illustrating an example of a method 800 for recommending a product or a service. In the method 800, at an operation 802, a set of first records can be provided from the memory. The set of first records can be for a set of characteristics of the potential user of the product or the service. A first record of the set of first records can have the field for the attribute of the product or the service. The value of the field of the first record of the set of first records can correspond to the relative degree of importance of the attribute with respect to the corresponding characteristic.

At the operation 504, the second record can be provided from the memory. The second record can be for the specific product or the specific service provider. The second record can have the field for the attribute. The value of the field of the second record can indicate that the specific product or the specific service provider has the attribute.

At an operation 804, a subset of the set of characteristics can be received from the client. For example, in the example case in which the product is a television set, as illustrated in the views (a) of FIGS. 6 and 7, a subset that includes the characteristic that the potential user intends to view the television set in a big room 618 and the characteristic that the potential user intends to view the television set in a darkly lit room 626 can be received from the potential user via the client. For example, in the example case in which the service is a medical practice, as illustrated in the views (b) of FIGS. 6 and 7, a subset that includes the characteristic that the potential user has allergies 634 and the characteristic that the potential user has health insurance through SureCare 650.

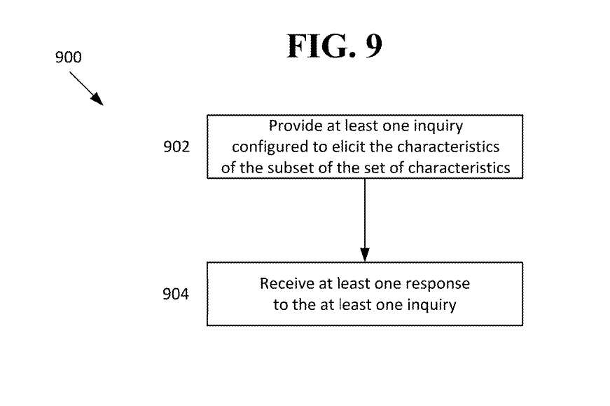

FIG. 9 is a flow diagram illustrating an example of a method 900 for receiving the subset of the set of characteristics at the operation 804. In the method 900, at an operation 902, at least one inquiry can be provided to the client. The at least one inquiry can be configured to elicit the characteristics of the subset of the set of characteristics. In an implementation, the at least one inquiry can be provided by selecting the at least one inquiry from a set of inquiries stored in the memory. In an implementation, the at least one inquiry can be provided by providing a graphical representation of the at least one inquiry. The graphical representation can be configured to be presented via a graphical user interface. For example, graphical representations of the at least one inquiry can be produced, configured to be presented via a graphical user interface, in the manner illustrated in FIGS. 4B through 4E. At an operation 904, at least one response to the at least one inquiry can be received from the client.

Returning to FIG. 8, at an operation 806, a subset of the set of first records can be determined at the processor. The subset of the set of first records can correspond to the subset of the set of characteristics. For example, in the example case in which the product is a television set, as illustrated in the views (a) of FIGS. 6 and 7, a subset that includes the first record 616 for the characteristic that the potential user intends to view the television set in a big room 618 and the first record 624 for the characteristic that the potential user intends to view the television set in a darkly lit room 626 can be determined at the processor. For example, in the example case in which the service is a medical practice, as illustrated in the views (b) of FIGS. 6 and 7, a subset that includes the first record 632 for the characteristic that the potential user has allergies 634 and the first record 648 for the characteristic that the potential user has health insurance through SureCare 650 can be determined at the processor.

At an operation 808, the specific value can be produced at the processor. The specific value can correspond to the relative degree of suitability of the specific product or the specific service provider with respect to the subset of the set of characteristics. In an implementation, the specific value can be equal to the sum of all the sums of the products. Each sum of the sums of products can correspond to a first record in the subset of the set of first records. For example, in the example case in which the product is a television set, as illustrated in the views (a) of FIGS. 6 and 7, the specific value for the specific product of the Sony ABC 123 television set 704 with respect to the characteristic that the potential user intends to view the television set in a big room 618 and the characteristic that the potential user intends to view the television set in a darkly lit room 626 can be equal to the sum of all the sums of the products [(−3×1)+(2×0)+(10×0)+(0×1)+(0×0)]+[(0×1)+(0×0)+(0×0)+(1×1)+(5×0)], which is −2. Such a specific value can correspond the relative degree of suitability of the Sony ABC 123 television set 704 for the potential user. For example, in the example case in which the service is a medical practice, as illustrated in the views (b) of FIGS. 6 and 7, the specific value for the specific service provider Smallville Medical 726 with respect to the characteristic that the potential user has allergies 634 and the characteristic that the potential user has health insurance through SureCare 650 can be equal to the sum of all the sums of the products [(10×1)+(0×1)+(7×1)+(3×1)]+[(7×1)+(5×1)+(10×1)+(0×1)], which is 42. Such a specific value can correspond the relative degree of suitability of Smallville Medical 726 for the potential user.

At the operation 508, the information about the specific product or the specific service provider can be transmitted to the client configured to be used by the potential user.

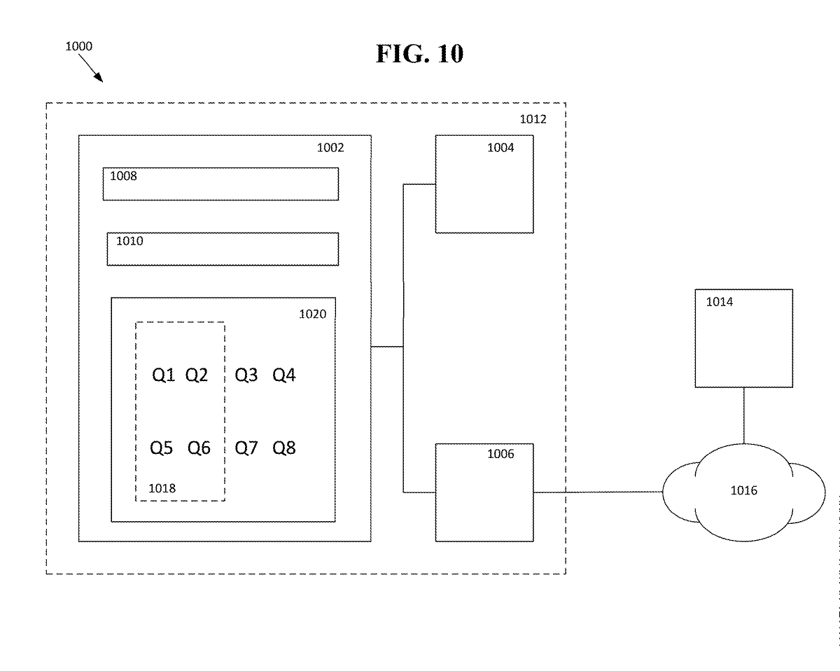

FIG. 10 is a block diagram of an example of a system 1000 for recommending a product or a service. The system 1000 can include a memory 1002, a processor 1004, and a network interface 1006. The memory 1002 can be configured to store a first record 1008. The first record 1008 can be for a characteristic of a potential user of the product or the service. The first record 1008 can have a field for an attribute of the product or the service. A value of the field of the first record 1008 can correspond to a relative degree of importance of the attribute with respect to the characteristic. The memory 1002 can be configured and to store a second record 1010. The second record 1010 can be for a specific product or a specific service provider. The second record 1010 can have a field for the attribute. A value of the field of the second record 1010 can indicate that the specific product or the specific service provider has the attribute. The processor 1004 can be configured to produce a specific value for the specific product or the specific service provider. The specific value can correspond to a relative degree of suitability of the specific product or the specific service provider with respect to the characteristic. The network interface 1006 can be configured to transmit, to a client configured to be used by the potential user, information about the specific product or the specific service provider. The information can be based on the specific value.

In an implementation, the memory 1002, the processor 1004, the interface 1006, or any combination thereof can be included in a server 1012. The server 1012 can be configured to interact with a client 1014 via a network 1016.

In an implementation, the first record 1008 can have a plurality of fields for a plurality of attributes and the second record 1010 can have a plurality of fields for the plurality of attributes. The processor 1004 can be configured to produce a sum of products. Each product of the products can be the value of the field of the first record 1008 multiplied by the value of the corresponding field of the second record 1010.

In an implementation, there can be a set of first records for a set of characteristics. The specific value can correspond to the relative degree of suitability of the specific product or the specific service provider with respect to the set of characteristics.

In an implementation, the sum of the products can be a set of sums of the products. The set of the sums of the products can correspond to the set of characteristics. The processor 1004 can be configured to produce a sum of all the sums of the products. Each sum of the sums of the products can correspond to a first record in the set of first records.

In an implementation, the network interface 1006 can be configured to receive, from the client 1014, a subset of the set of characteristics. The processor 1004 can be configured to determine a subset of the set of first records. The subset of the set of first records can correspond to the subset of the set of characteristics. The specific value can correspond to the relative degree of suitability of the specific product or the specific service provider with respect to the subset of the set of characteristics.

In an implementation, the sum of the products can be a set of sums of the products. The set of the sums of the products can correspond to the subset of the set of characteristics. The processor 1004 can be configured to produce a sum of all the sums of the products. Each sum of the sums of the products can correspond to a first record in the set of first records.

In an implementation, the network interface 1006 can be configured to provide, to the client 1014, at least one inquiry 1018. The at least one inquiry 1018 can have a graphical representation. The graphical representation can be configured to be presented via a graphical user interface. For example, graphical representations of the at least one inquiry 1018 can be produced, configured to be presented via a graphical user interface, in the manner illustrated in FIGS. 4B through 4E. The at least one inquiry 1018 can be configured to elicit the characteristics of a subset of the set of characteristics. The network interface 1006 can be configured to receive, from the client 1014, at least one response to the at least one inquiry 1018 that corresponds to the subset of the set of characteristics. The processor 1004 can be configured to determine a subset of the set of first records. The subset of the set of first records can correspond to the subset of the set of characteristics. The specific value can correspond to the relative degree of suitability of the specific product or the specific service provider with respect to the subset of the set of characteristics.

In an implementation, the processor 1004 can be configured to select the at least one inquiry 1018 from a set of inquiries 1020 in the memory 1002.

In an implementation, there can be a set of second records for a set of specific products or specific service providers. The specific value can include a set of specific values. The set of specific values can correspond to the set of specific products or specific service providers. The information can include a set of information. The set of information can correspond to the set of specific products or specific service providers. The information in the set of information can be configured to be presented in an order. The order can be according the specific values of the set of specific values.

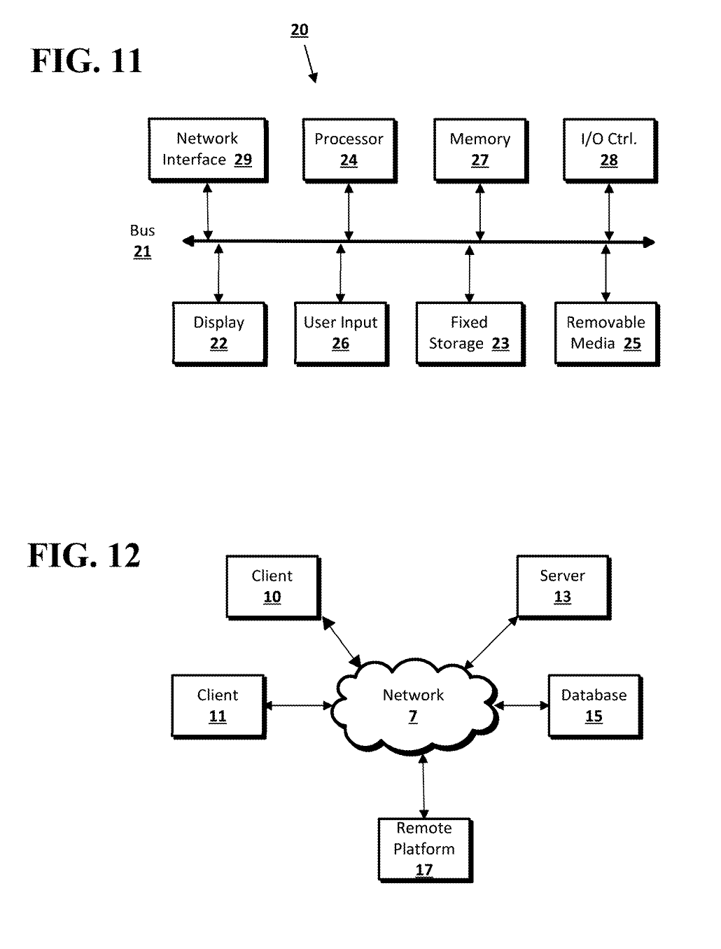

Implementations of the presently disclosed subject matter may be implemented in and used with a variety of component and network architectures. FIG. 11 is a block diagram of an example of a computer 20 suitable for implementations of the presently disclosed subject matter. The computer 20 includes a bus 21 which interconnects major components of the computer 20, such as, for example, a central processor 24, a memory 27 (typically RAM, but which may also include ROM, flash RAM, or the like), an input/output controller 28, a user display 22 (such as, for example, a display screen via a display adapter), a user input interface 26 (which may include one or more controllers and associated user input devices such as a keyboard, mouse, and the like), and an I/O controller 28 (which may be closely coupled to the user input interface 26), fixed storage 23 (such as, for example, a hard drive, flash storage, Fibre Channel network, SAN device, SCSI device, and the like), a removable media component 25 operative to control and receive an optical disk, flash drive, and the like, and a network interface 29.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. The network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection, or the like. For example, the network interface 29 may allow the computer to communicate with other computers via one or more local, wide-area, or other networks, as shown in FIG. 12.

Many other devices or components (not shown) may be connected in a similar manner (e.g., document scanners, digital cameras, and so on). Conversely, not all of the components shown in FIG. 11 need to be present to practice the present disclosure. The components can be interconnected in different ways from that shown. The operation of a computer such as that shown in FIG. 11 is readily known in the art and is not discussed in detail in this application. Code to implement the present disclosure can be stored in computer-readable storage media such as one or more of the memory 27, fixed storage 23, removable media 25, or on a remote storage location.

FIG. 12 shows an example of a network arrangement according to an implementation of the disclosed subject matter. One or more clients 10, 11, such as local computers, smart phones, tablet computing devices, and the like may connect to other devices via one or more networks 7. The network 7 may be a local network, wide-area network, the Internet, or any other suitable communication network or networks, and may be implemented on any suitable platform including wired and/or wireless networks. The clients 10, 11 may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17, such as, for example, cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general-purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, thereby to enable others skilled in the art to utilize those implementations as well as various implementations with various modifications as may be suited to the particular use contemplated.

1. A computer-implemented method for recommending a product or a service, comprising:
providing, from a memory, a first record, the first record for a characteristic of a potential user of the product or the service, the first record having a field for an attribute of the product or the service, a value of the field of the first record corresponding to a relative degree of importance of the attribute with respect to the characteristic;
providing, from the memory, a second record, the second record for a specific product or a specific service provider, the second record having a field for the attribute, a value of the field of the second record indicating that the specific product or the specific service provider has the attribute;
producing, at a processor, a specific value for the specific product or the specific service provider, the specific value corresponding to a relative degree of suitability of the specific product or the specific service provider with respect to the characteristic; and
transmitting, to a client configured to be used by the potential user, information about the specific product or the specific service provider, the information based on the specific value.

2. The method of claim 1, wherein the transmitting comprises transmitting in response to the specific value being greater than a threshold.

3. The method of claim 1, wherein at least one of the memory, the processor, or any combination thereof is included in a server, the server configured to interact with the client via a network.

4. The method of claim 1, wherein the attribute comprises a first attribute and a second attribute, wherein the value of the field of the first record comprises a value of a first field of the first record and a value of a second field of the first record, wherein the value of the field of the second record comprises a value of a first field of the second record and a value of a second field of the second record, and wherein the producing comprises producing a first sum of a first product added to a second product, the first product being a product of the value of the first field of the first record multiplied by the value of the first field of the second record, the second product being a product of the value of the second field of the first record multiplied by the value of the second field of the second record.

5. The method of claim 4, wherein the first record for the characteristic comprises a set of first records for a set of characteristics, and wherein the specific value corresponds to the relative degree of suitability of the specific product or the specific service provider with respect to the set of characteristics.

6. The method of claim 5, wherein the first sum comprises a set of first sums, the set of first sums corresponding to the set of characteristics, and wherein the producing comprises producing a second sum, the second sum being a sum of all the first sums in the set of first sums.

7. The method of claim 5, further comprising:
receiving, from the client, a subset of the set of characteristics; and
determining, at the processor, a subset of the set of first records, the subset of the set of first records corresponding to the subset of the set of characteristics,
wherein the specific value corresponds to the relative degree of suitability of the specific product or the specific service provider with respect to the subset of the set of characteristics.

8. The method of claim 7, wherein the first sum comprises a set of first sums, the set of first sums corresponding to the subset of the set of characteristics, and wherein the producing comprises producing a second sum, the second sum being a sum of all the first sums in the set of first sums.

9. The method of claim 7, wherein the receiving comprises:
providing, to the client, at least one inquiry, the at least one inquiry configured to elicit the characteristics of the subset of the set of characteristics; and
receiving, from the client, at least one response to the at least one inquiry.

10. The method of claim 9, wherein the providing the at least one inquiry comprises selecting the at least one inquiry from a set of inquiries stored in the memory.

11. The method of claim 9, wherein the providing the at least one inquiry comprises providing a graphical representation of the at least one inquiry, the graphical representation configured to be presented via a graphical user interface.

12. The method of claim 1, wherein the second record for the specific product or the specific service provider comprises a set of second records for a set of specific products or specific service providers, wherein the specific value comprises a set of specific values, the set of specific values corresponding to the set of specific products or specific service providers, wherein the information comprises a set of information, the set of information corresponding to the set of specific products or specific service providers, and wherein the information in the set of information is configured to be presented in an order, the order according to the specific values of the set of specific values.

13. A system for recommending a product or a service, comprising:
a memory configured to store a first record, the first record for a characteristic of a potential user of the product or the service, the first record having a field for an attribute of the product or the service, a value of the field of the first record corresponding to a relative degree of importance of the attribute with respect to the characteristic, and to store a second record, the second record for a specific product or a specific service provider, the second record having a field for the attribute, a value of the field of the second record indicating that the specific product or the specific service provider has the attribute;
a processor configured to produce a specific value for the specific product or the specific service provider, the specific value corresponding to a relative degree of suitability of the specific product or the specific service provider with respect to the characteristic; and
a network interface configured to transmit, to a client configured to be used by the potential user, information about the specific product or the specific service provider, the information based on the specific value.

14. The system of claim 13, wherein at least one of the memory, the processor, the interface, or any combination thereof is included in a server, the server configured to interact with the client via a network.

15. The system of claim 13, wherein the attribute comprises a first attribute and a second attribute, wherein the value of the field of the first record comprises a value of a first field of the first record and a value of a second field of the first record, wherein the value of the field of the second record comprises a value of a first field of the second record and a value of a second field of the second record, and wherein the processor is configured to produce a first sum of a first product added to a second product, the first product being a product of the value of the first field of the first record multiplied by the value of the first field of the second record, the second product being a product of the value of the second field of the first record multiplied by the value of the second field of the second record.

16. The system of claim 15, wherein the first record for the characteristic comprises a set of first records for a set of characteristics, wherein the specific value corresponds to the relative degree of suitability of the specific product or the specific service provider with respect to the set of characteristics, wherein the first sum comprises a set of first sums, the set of first sums corresponding to the set of characteristics, and wherein the processor is configured to produce a second sum, the second sum being a sum of all the first sums in the set of first sums.

17. The system of claim 15, wherein the first record for the characteristic comprises a set of first records for a set of characteristics, wherein the specific value corresponds to the relative degree of suitability of the specific product or the specific service provider with respect to the set of characteristics, wherein the network interface is configured to receive, from the client, a subset of the set of characteristics, wherein the processor is configured to determine a subset of the set of first records, the subset of the set of first records corresponding to the subset of the set of characteristics, wherein the specific value corresponds to the relative degree of suitability of the specific product or the specific service provider with respect to the subset of the set of characteristics, wherein the first sum comprises a set of first sums, the set of first sums corresponding to the subset of the set of characteristics, and wherein the processor is configured to produce a second sum, the second sum being a sum of all the first sums in the set of first sums.

18. The system of claim 15, wherein the first record for the characteristic comprises a set of first records for a set of characteristics, wherein the specific value corresponds to the relative degree of suitability of the specific product or the specific service provider with respect to the set of characteristics, wherein the network interface is configured to provide, to the client, at least one inquiry, the at least one inquiry having a graphical representation, the graphical representation configured to be presented via a graphical user interface, the at least one inquiry configured to elicit the characteristics of a subset of the set of characteristics, wherein the network interface is configured to receive, from the client, at least one response to the at least one inquiry that corresponds to the subset of the set of characteristics, wherein the processor is configured to determine a subset of the set of first records, the subset of the set of first records corresponding to the subset of the set of characteristics, and wherein the specific value corresponds to the relative degree of suitability of the specific product or the specific service provider with respect to the subset of the set of characteristics.

19. The system of claim 18, wherein the processor is configured to select the at least one inquiry from a set of inquiries stored in the memory.

20. A non-transitory computer-readable medium storing computer code for controlling one or more processor components to cause the one or more processor components to recommend a product or a service, the code including instructions to:
provide a first record, the first record for a characteristic of a potential user of the product or the service, the first record having a field for an attribute of the product or the service, a value of the field of the first record corresponding to a relative degree of importance of the attribute with respect to the characteristic;
provide a second record, the second record for a specific product or a specific service provider, the second record having a field for the attribute, a value of the field of the second record indicating that the specific product or the specific service provider has the attribute;
produce a specific value for the specific product or the specific service provider, the specific value corresponding to a relative degree of suitability of the specific product or the specific service provider with respect to the characteristic; and
transmit, to a client configured to be used by the potential user, information about the specific product or the specific service provider, the information based on the specific value.
